(19) United States
(12) Patent Application Publication
(10) Pub. No.: US 2015/0168262 A1
(43) Pub. Date: Jun. 18, 2015

(54) SINGLE CRYSTAL TURBINE BLADE LIFING PROCESS AND SYSTEM

(71) Applicant: Solar Turbines Incorporated, San Diego, CA (US)

(72) Inventors: Richard James Green, Poway, CA (US); Jonathan Paul Douglas, Dorking/Surrey (GB)

(73) Assignee: Solar Turbines Incorporated, San Diego, CA (US)

(21) Appl. No.: 14/081,923

(22) Filed: Nov. 15, 2013

Related U.S. Application Data
(60) Provisional application No. 61/962,291, filed on Oct. 11, 2013.

(51) Int. Cl. G01M 15/14

(52) U.S. Cl. CPC G01M 15/14

(57) ABSTRACT

A system and methods for lifing a single crystal turbine blade of a gas turbine engine is disclosed. The system and methods determine the anisotropic strain of the single crystal turbine blade caused by fatigue and creep by resolving the shear stresses on each of the primary slip systems of the single crystal turbine blade. The system and methods use a ductility exhaustion method to combine the anisotropic fatigue and creep strains to determine the operating life of the single crystal turbine blade.

### TECHNICAL FIELD

The present disclosure generally pertains to gas turbine engines, and is more particularly directed toward a lifing process and system for single crystal turbine blades of a gas turbine engine.

### BACKGROUND

Gas turbine engines include an inlet, a compressor section, a combustor section, a turbine section, and an exhaust. The extreme operating conditions of the turbine section result in creep and fatigue damage to the turbine components including the turbine blades. Processes and systems for determining the life of turbine components are used to predict when the turbine components might fail so that the turbine components can be replaced prior to failure.

U.S. Pat. No. 7,162,373 to Y. Kadioglu is directed to a method for predicting a remaining operational life of a turbine component including: obtaining crack flaw data regarding current crack flaws in the turbine component; using the crack flaw data with data regarding the structure and operating conditions of the turbine component to determine force loads applied to the turbine component and generate crack propagation data; applying a probabilistic analysis to the crack flaw data and the generated crack propagation data to predict a time to failure of the component by iteratively determining the force loads for successive periods of time.

The present disclosure is directed toward overcoming one or more of the problems discovered by the inventors or that is known in the art.

### SUMMARY OF THE DISCLOSURE

A lifing system for single crystal turbine blades of a gas turbine engine is disclosed. The lifing system includes an anisotropic module, a fatigue module, a creep module, and a ductility exhaustion module. The anisotropic module is configured to convert the stress determined in an orthotropic manner into an anisotropic inelastic strain vector by determining the resolved shear stresses on the primary octahedral and cubic slip systems of the single crystal turbine blade.

The fatigue module is configured to determine a plastic response stress of a ramp period in an orthotropic manner, provide the plastic response stress to the anisotropic module, receive an anisotropic plastic response inelastic strain vector from the anisotropic module, and determine a plastic response strain rate from the anisotropic plastic response inelastic strain vector.

The creep module is configured to determine a viscoplastic response stress of the dwell period in an orthotropic manner, provide the viscoplastic response stresses to the anisotropic module, receive an anisotropic viscoplastic response inelastic strain vector from the anisotropic module, and determine a viscoplastic response strain rate from the anisotropic viscoplastic response inelastic strain vector.

The ductility exhaustion module is configured to determine the exhausted ductility of the single crystal turbine blade by determining an accumulated inelastic strain of the load cycle with the plastic response strain rate, the viscoplastic response strain rate, and a ductility exhaustion curve and comparing the accumulated inelastic strain to an available strain.

A method for determining the damage accumulated on a single crystal turbine blade during a load cycle of a gas turbine engine is also disclosed. The load cycle includes a ramp period and a dwell period. The method includes determining a ramp period anisotropic stress including resolving ramp period stress determined in an orthotropic manner into ramp period shear stresses on the primary slip systems of the turbine blade. The method also includes determining a ramp period anisotropic strain from the ramp period anisotropic stress using a stress-strain curve for the material and determining a ramp period strain rate from the ramp period anisotropic strain. The method further includes determining a ramp period damage from the ramp period strain rate by using a ductility exhaustion curve for the material.

The method also includes determining a dwell period anisotropic stress including resolving dwell period stress determined in an orthotropic manner into dwell period shear stresses on the primary slip systems of the turbine blade. The method further includes determining a dwell period anisotropic strain from the dwell period anisotropic stress and determining a dwell period strain rate from the dwell period anisotropic strain. The method even further includes determining a dwell period damage from the dwell period strain rate by using the ductility exhaustion curve for the material. The method lastly includes combining the ramp period damage and the dwell period damage for the load cycle.

### BRIEF DESCRIPTION OF THE DRAWINGS

FIG. 1 is a schematic illustration of an exemplary gas turbine engine.

FIG. 2 is a perspective view of an exemplary single crystal turbine blade for the gas turbine engine of FIG. 1.

FIG. 3 is an exemplary chart of a ductility exhaustion curve.

FIG. 4 is an exemplary chart of a stress-strain curve.

FIG. 5 is a functional block diagram of a lifing system for a single crystal turbine blade such as the turbine blade of FIG. 2.

FIG. 6 is a flowchart of a process for determining the damage accumulated on a single crystal turbine blade, such as the turbine blade of FIG. 2, caused by one gas turbine engine load cycle.

FIG. 7 is a flowchart of a process for determining the operating life of a single crystal turbine blade such as the turbine blade of FIG. 2.

### DETAILED DESCRIPTION

The systems and methods disclosed herein include a gas turbine engine and a system for lifing single crystal turbine blades of the gas turbine engine. The systems and methods use a ductility exhaustion approach to combine the damaging effects of creep and fatigue. Ductility exhaustion is based on strain rate of both the plastic response during a transient portion of the load cycle, defined as the cyclic or fatigue component and the strain rate from the viscoplastic response during the dwell portion of the load cycle or creep component. The systems and methods use the fatigue and creep stresses determined in an orthotropic manner and convert them into anisotropic stresses and strains by resolving the stresses determined in an orthotropic manner into the shear stresses on the primary slip planes. The shear stresses are then used to determine the anisotropic fatigue and creep strains and strain rates for the single crystal turbine blade. The strain rate for the single crystal turbine blade is used to determine the available ductility from the single crystal material's ductility exhaustion curve. The available ductility at each strain rate is then compared with the amount of strain accumulated during that particular inelastic portion of the load cycle. Damage is considered to be the ratio of accumulated strain at a given strain rate relative to the available strain.

FIG. 1 is a schematic illustration of an exemplary gas turbine engine 100. Some of the surfaces have been left out or exaggerated (here and in other figures) for clarity and ease of explanation. Also, the disclosure may reference a forward and an aft direction. Generally, all references to “forward” and “aft” are associated with the flow direction of primary air (i.e., air used in the combustion process), unless specified otherwise. For example, forward is “upstream” relative to primary air flow, and aft is “downstream” relative to primary air flow.

In addition, the disclosure may generally reference a center axis 95 of rotation of the gas turbine engine, which may be generally defined by the longitudinal axis of its shaft 120 (supported by a plurality of bearing assemblies 150). The center axis 95 may be common to or shared with various other engine concentric components. All references to radial, axial, and circumferential directions and measures refer to center axis 95, unless specified otherwise, and terms such as “inner” and “outer” generally indicate a lesser or greater radial distance from, wherein a radial 96 may be in any direction perpendicular and radiating outward from center axis 95.

A gas turbine engine 100 includes an inlet 110, a shaft 120, a compressor 200, a combustor 300, a turbine 400, an exhaust 500, and a power output coupling 600. The gas turbine engine 100 may have a single shaft or a multiple shaft configuration.

The compressor 200 includes a compressor rotor assembly 210, compressor stationary vanes (stators) 250, and inlet guide vanes 255. The compressor rotor assembly 210 mechanically couples to shaft 120. As illustrated, the compressor rotor assembly 210 is an axial flow rotor assembly. The compressor rotor assembly 210 includes one or more compressor disk assemblies 220. Each compressor disk assembly 220 includes a compressor rotor disk that is circumferentially populated with compressor rotor blades. Stators 250 axially follow each of the compressor disk assemblies 220. Each compressor disk assembly 220 paired with the adjacent stators 250 that follow the compressor disk assembly 220 is considered a compressor stage. Compressor 200 includes multiple compressor stages. Inlet guide vanes 255 axially precede the compressor stages.

The combustor 300 includes one or more fuel injectors 310 and includes one or more combustion chambers 390. The fuel injectors 310 may be annularly arranged about center axis 95.

The turbine 400 includes a turbine rotor assembly 410 and turbine nozzles 450. The turbine rotor assembly 410 mechanically couples to the shaft 120. As illustrated, the turbine rotor assembly 410 is an axial flow rotor assembly. The turbine rotor assembly 410 includes one or more turbine disk assemblies 420. Each turbine disk assembly 420 includes a turbine disk that is circumferentially populated with single crystal turbine blades 430. Turbine nozzles 450 axially precede each of the turbine disk assemblies 420. Each turbine disk assembly 420 paired with the adjacent turbine nozzles 450 that precede the turbine disk assembly 420 is considered a turbine stage. Turbine 400 includes multiple turbine stages.

The exhaust 500 includes an exhaust diffuser 510 and an exhaust collector 520.

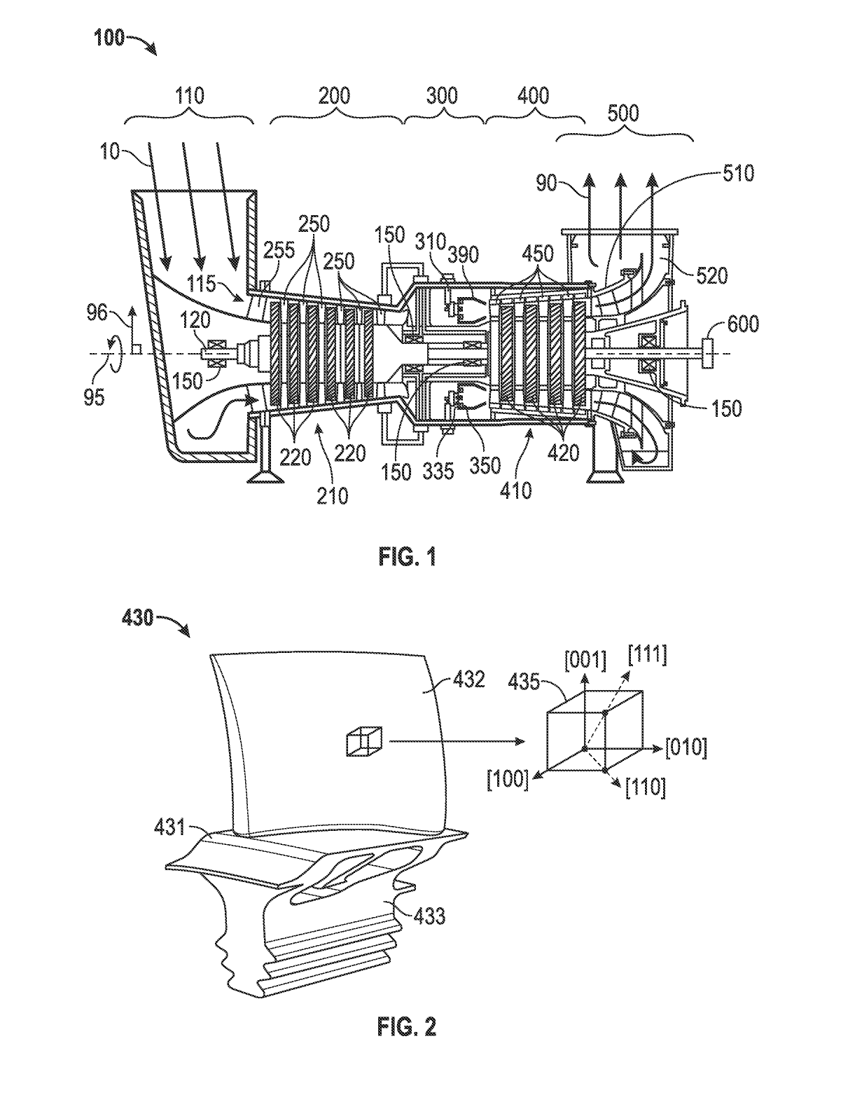

FIG. 2 is a perspective view of an exemplary single crystal turbine blade 430 for the gas turbine engine 100 of FIG. 1. Single crystal turbine blade 430 may include a platform 431, an airfoil 432, and a root 433 all formed from a single crystal or formed substantially from a single crystal. The single crystal may include an anisotropic face centered cubic (FCC) material. Unit cell 435 illustrates the FCC structure of single crystal turbine blade 430. FCC materials include multiple slip systems including octahedral and cubic slip systems. Airfoil 432 extends outward, in a first direction, from platform 431. When single crystal turbine blade 430 is coupled to a turbine disk in turbine disk assembly 420, airfoil 432 extends radially outward from platform 431 relative to center axis 95. Root 433 extends inward from platform 431, in a second direction, in the direction opposite airfoil 432 or opposite the first direction.

One or more of the above components (or their subcomponents) may be made from stainless steel and/or durable, high temperature materials known as “superalloys”. A superalloy, or high-performance alloy, is an alloy that exhibits excellent mechanical strength and creep resistance at high temperatures, good surface stability, and corrosion and oxidation resistance. Superalloys may include materials such as alloy x, WASPALOY, RENE alloys, alloy 188, alloy 230, INCOLOY, MP98T, TMS alloys, and CMSX single crystal alloys, such as CMSX-4.

The lifing system determines the damage accumulation in an FCC single crystal turbine blade 430 of one or more load cycles of the gas turbine engine (GTE) 100 by determining the anisotropic strains caused by the load cycles on the FCC single crystal turbine blade 430 and applying those anisotropic strains to a ductility exhaustion method. A load cycle includes ramp periods, the transient periods such as start-up, ramp up, or ramp down periods, where the load and operating temperatures are increased or decreased, and dwell periods, the steady state periods, where the load and the operating temperatures are held relatively constant.

Test data may be used to generate a ductility exhaustion curve and a stress strain curve to be used with the lifing system. The ductility exhaustion curve may be determined by using creep and tensile test data. This data provides ductility at the point of failure which is dependent on the rate of the applied strain. A ductility exhaustion curve can be created for a specific material from a range of tensile and creep tests.

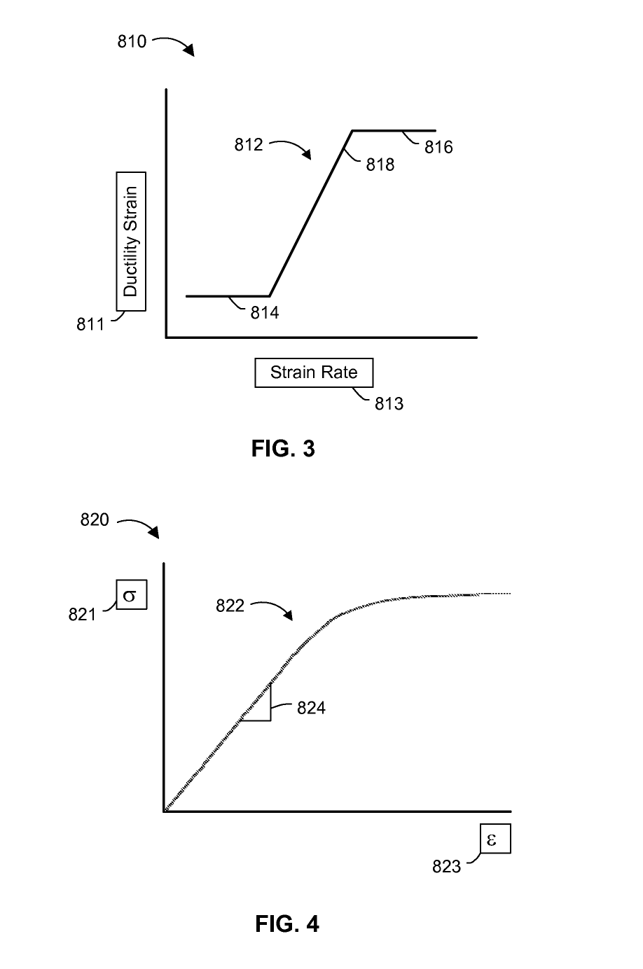

FIG. 3 is an exemplary chart 810 of a ductility exhaustion curve 812. The ductility exhaustion curve 812 is a plot of the ductility strain (as a percentage) 811 versus the strain rate (change in strain per change in time) 813 of the material. The ductility exhaustion curve 812 may include a lower ductility shelf 814 for strain rates below a given amount where the ductility strain is constant, an upper ductility shelf 816 for strain rates above a given amount where the ductility strain is also constant, and a transition region 818 at strain rates between the lower ductility shelf 814 and the upper ductility shelf 816.

Thousands of hours of test data, including creep test data and tensile test data, was used to determine that the materials used for the single crystal turbine blade 430 such as CMSX single crystal alloys exhibit this ductility behavior including the lower ductility shelf 814, the upper ductility shelf 816, and the transition region 818. The creep tests represent data at the lower strain rates, forming the transition region 818 and lower ductility shelf 814, and the tensile tests represent the data at the higher stain rates, or upper ductility shelf 816 as illustrated in FIG. 3. Strain rate can then be used to predict the damage throughout the load cycle, including dwell periods by determining the average strain rate for the inelastic portion of the resultant stress strain curve for the load cycle. Damage is determined from the ratio of accumulated strain during the inelastic component of the load cycle, (typically predicted using numerical models) to the available ductility at the average strain rate for that inelastic portion of the load cycle.

FIG. 4 is an exemplary chart 820 of a stress-strain curve 822. The stress-strain curve 822 may also be determined by test data. The stress-strain curve 822 illustrated demonstrates the relationship between the stress (σ) 821, the strain (ε) 822 and Young's modulus (E) 824.

The slip system data for a given material may include the relationship between the shear stress component and the resolved shear stresses of the slip system and the relationship between the resolved shear stresses of the slip system and the resolved shear strain on each slip system.

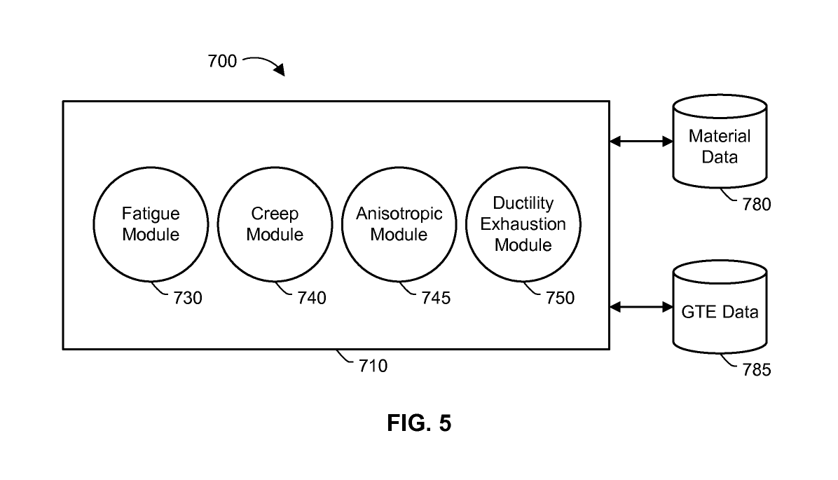

FIG. 5 is a functional block diagram of a lifing system 700 for a single crystal turbine blade such as the single crystal turbine blade 430 of FIG. 2. The lifing system 700 may be implemented on a computer 710 or server that includes a processor for executing computer-software instructions, and a memory that can be used to store executable software program modules that can be executed by the processor. The memory includes a non-transitory computer readable medium used to store program instructions executable by the processor. The lifing system 700 includes a fatigue module 730, a creep module 740, an anisotropic module 745, and a ductility exhaustion module 750.

The fatigue module 730 determines the plastic response strain rate for the single crystal turbine blade 430 due to a load cycle of the GTE 100. The plastic response of the single crystal turbine blade 430 may be caused by the ramp periods of the load cycle. First the fatigue module 730 determines the plastic response stresses in an orthotropic manner or what the plastic response stresses would be for an orthotropic material. Given the complexity of the single crystal turbine blade 430 along with the complex nature of the load cycle, analyses are typically performed using a finite element analysis method The finite element analysis method may use the gas turbine engine operating conditions during the ramp period including the temperature and pressure of the gas turbine engine 100 to determine the plastic response stresses. The fatigue module 730 then provides the determined plastic response stresses to the anisotropic module 745. The anisotropic module 745 converts the plastic response stresses to an anisotropic plastic response inelastic strain vector or to an anisotropic formulation as described below. The anisotropic module 745 may then return the anisotropic plastic response inelastic strain vector to the fatigue module 730.

The fatigue module 730 may use the anisotropic plastic response inelastic strain vector to determine the anisotropic plastic response elastic strain vector, by subtracting the anisotropic plastic response inelastic strain vector from the total plastic response strain. The anisotropic plastic response stress vector may then be determined by multiplying the anisotropic plastic response elastic strain by the elastic stiffness tensor. As everything should be in equilibrium, all loads and reactions should sum to zero. The fatigue module 730 may use these relationships as part of the solution iteration to determine the anisotropic plastic response stress vector from the anisotropic plastic response inelastic strain vector.

The fatigue module 730 may then use an elastic-plastic-stress-strain curve, such as the stress-strain curve 822 of FIG. 4 to determine the resulting anisotropic plastic response strain from the determined anisotropic plastic response stress vector. The resultant plastic strain rate may be determined by dividing the change in the anisotropic plastic strain (Δεₚ) by the ramp period (Δt_{T}) of the load cycle.

The creep module 740 determines the viscoplastic response strain rate for the single crystal turbine blade 430 due to the load cycle. The creep or viscoplastic response of the single crystal turbine blade 430 occurs during the dwell periods of the load cycle. First the creep module 740 determines the viscoplastic response stresses in an orthotropic manner or what the viscoplastic stresses would be for an orthotropic material, and determines the temperature during the start of the steady state period. Any orthotropic model may be used. The creep module 740 then provides the determined viscoplastic response stresses to the anisotropic module 745. The anisotropic module 745 converts the viscoplastic response stresses to anisotropic viscoplastic response stresses or to an anisotropic formulation as described below. The anisotropic module 745 may then return the anisotropic viscoplastic response inelastic strain vector to the creep module 740.

The creep module 740 may use the anisotropic viscoplastic response inelastic strain vector to determine the anisotropic viscoplastic response elastic strain vector, by subtracting the anisotropic viscoplastic response inelastic strain vector from the total viscoplastic response strain. The anisotropic viscoplastic response stress vector may then be determined by multiplying the anisotropic viscoplastic response elastic strain by the elastic stiffness tensor. As everything should be in equilibrium, all loads and reactions should sum to zero. The creep module 740 may use these relationships as part of the solution iteration to determine the anisotropic viscoplastic response stress vector from the anisotropic viscoplastic response inelastic strain vector.

A typical strain rate based creep model, such as a power law creep equation may be used to obtain the creep or anisotropic viscoplastic strain from the determined anisotropic viscoplastic stress vector and temperature over the dwell period. The complexity of the creep strain rate equation will be dependent on the level of accuracy needed and the material. The resultant creep or anisotropic viscoplastic strain (Δε_{c}) can then be divided by the change in time over the dwell period (Δt_{d}) to determine the strain rate for the dwell period of the single crystal turbine blade 430. Given the complexity of single crystal turbine blades 430 along with the complex nature of the load cycle, analyses are typically performed using a finite element analysis method. The creep module 740 uses the specific operating conditions of the gas turbine engine 100 during the dwell period to determine the viscoplastic strain rates.

The single crystal turbine blade 430 stresses and strains are a combination of the thermal and mechanical loading during the load cycle. Wherein the thermal component of stress is subject to relaxation during dwell as a function of creep and the mechanical component of stress is subject to redistribution as a result of the plastic strains.

The anisotropic module 745 extracts the orthotropic stress tensors and converts the stresses provided by either the fatigue module 730 or the creep module 740 into anisotropic stresses by resolving the shear stresses onto the primary octahedral and primary cubic slip systems. The newly resolved shear stresses are then used to calculate shear strains (ramp period shear strains for the fatigue module 730 and dwell period shear strains for the creep module 740) and subsequently an updated stress vector that is passed back to either the fatigue module 730 or the creep module 740. The updated stress vector may be resolved as part of the equilibrium equations of an orthotropic model or finite element analysis method or model. The anisotropic module 745 can be a subroutine of a finite element analysis method or software.

Single crystal turbine blades 430 act as an anisotropic material and as such, loading of these types of anisotropic or FCC structures gives rise to resolved shear stresses on each of the primary octahedral and cubic slip systems. The shear stresses in turn, result in shear deformation and permanent strain from creep or plasticity can be determined from these shear deformations.

Stresses and strains are Tensors and in order to determine the anisotropic stress state, the orthotropic stress tensors need to be transformed into the equivalent anisotropic stress state. This is achieved by resolving the shear stress component and rotating the orthotropic stress tensor, by tensor transformation, to align with the octahedral and cubic slip systems. For each slip system, the shear stress component defines the resolved shear stress on the slip system. The resolved shear stress may be defined by:

τ=σ cos Φ cos λ

where τ is the resolved shear stress, σ is the orthotropic stress, Φ is the angle between the normal of the slip plane and the direction of the applied force, and λ is the angle between the slip plane direction and the direction of the applied force.

The anisotropic module 745 determines the resolved shear stresses for the primary slip systems of the single crystal turbine blade 430. This determination may be dependent on the type of material used for the single crystal turbine blade 430 and may be derived from the resolved shear stress definition defined above. For example, the resolved shear stresses for the primary slip systems of the single crystal turbine blade 430 of CMSX-4 may be determined by the equations listed in Table 1. Table 1 illustrates the 12 primary octahedral resolved shear stresses and the 6 primary cubic resolved shear stresses for a CMSX-4 single crystal turbine blade 430 in an FCC anisotropic system.

TABLE 1

| Slip System | Slip | Slip | |
|---|---|---|---|
| Number | Plane (n) | Direction (b) | Resolved Shear Stress (τᵢⱼ) |
| 1 | (111) | [ 1̅01] | $\frac{1}{\sqrt{σ}} ( {σ}_{33} - {σ}_{11} - {σ}_{12} + {σ}_{23} )$ |
| 2 | (111) | [0 1̅1] | $\frac{1}{\sqrt{σ}} ( {σ}_{33} - {σ}_{21} - {σ}_{22} + {σ}_{31} )$ |
| 3 | (111) | [1 1̅0] | $\frac{1}{\sqrt{σ}} ( {σ}_{11} + {σ}_{13} - {σ}_{22} - {σ}_{23} )$ |
| 4 | (1 1̅1) | [011] | $\frac{1}{\sqrt{σ}} ( {σ}_{21} - {σ}_{22} + {σ}_{31} + {σ}_{33} )$ |
| 5 | (1 1̅1) | [ 1̅01] | $\frac{1}{\sqrt{σ}} ( {σ}_{12} - {σ}_{11} - {σ}_{32} + {σ}_{33} )$ |
| 6 | (1 1̅1) | [ 1̅ 1̅1] | $\frac{1}{\sqrt{σ}} ( {σ}_{22} - {σ}_{13} - {σ}_{11} - {σ}_{23} )$ |
| 7 | ( 1̅11) | [0 1̅1] | $\frac{1}{\sqrt{σ}} ( {σ}_{21} - {σ}_{22} - {σ}_{31} + {σ}_{33} )$ |
| 8 | ( 1̅11) | [101] | $\frac{1}{\sqrt{σ}} ( {σ}_{12} - {σ}_{11} + {σ}_{23} + {σ}_{33} )$ |
| 9 | ( 1̅11) | [110] | $\frac{1}{\sqrt{σ}} ( {σ}_{22} - {σ}_{11} + {σ}_{13} + {σ}_{23} )$ |
| 10 | ( 1̅ 1̅1) | [101] | $\frac{1}{\sqrt{σ}} ( {σ}_{33} - {σ}_{11} - {σ}_{12} - {σ}_{32} )$ |
| 11 | ( 1̅ 1̅1) | [011] | $\frac{1}{\sqrt{σ}} ( {σ}_{33} - {σ}_{21} - {σ}_{22} - {σ}_{31} )$ |
| 12 | ( 1̅ 1̅1) | [ 1̅10] | $\frac{1}{\sqrt{σ}} ( {σ}_{11} - {σ}_{13} - {σ}_{22} + {σ}_{23} )$ |
| 13 | (001) | [110] | $\frac{1}{\sqrt{2}} ( {σ}_{23} + {σ}_{13} )$ |
| 14 | (001) | [ 1̅10] | $\frac{1}{\sqrt{2}} ( {σ}_{23} - {σ}_{13} )$ |
| 15 | (001) | [101] | $\frac{1}{\sqrt{2}} ( {σ}_{32} + {σ}_{12} )$ |
| 16 | (100) | [ 1̅01] | $\frac{1}{\sqrt{2}} ( {σ}_{32} - {σ}_{12} )$ |
| 17 | (100) | [0 1̅1] | $\frac{1}{\sqrt{2}} ( {σ}_{32} - {σ}_{12} )$ |
| 18 | (100) | [011] | $\frac{1}{\sqrt{2}} ( {σ}_{31} + {σ}_{21} )$ |

The anisotropic module 745 then determines the shear strain for each slip system. The shear strain for each slip system may then be determined from the resolved shear stresses. The shear strain (γ) for each slip system may be calculated using constitutive equations for creep and plasticity. This may include a shear strain for each of the 12 primary octahedral slip systems and each of the 6 primary cubic slip systems.

The anisotropic module 745 then determines an inelastic strain for each strain component and sums the inelastic strain components into an inelastic strain vector. For an FCC material, the strain components may include the x or 11 direction, the y or 22 direction, the z or 33 direction, the xy or 12 direction, the xz or 13 direction, and the yz or 23 direction. The strain components may be determined by the equations illustrated in Table 2.

TABLE 2

| Strain Component | Inelastic Strain |
|---|---|
| ε₁₁ | $\frac{1}{\sqrt{6}} ( {γ}_{3} - {γ}_{1} - {γ}_{5} - {γ}_{6} - {γ}_{8} - {γ}_{9} - {γ}_{10} + {γ}_{12} )$ |
| ε₂₂ | $\frac{1}{\sqrt{6}} ( {γ}_{6} - {γ}_{2} - {γ}_{3} - {γ}_{4} - {γ}_{7} + {γ}_{9} - {γ}_{11} - {γ}_{12} )$ |
| ε₃₃ | $\frac{1}{\sqrt{6}} ( {γ}_{1} + {γ}_{2} + {γ}_{4} + {γ}_{5} + {γ}_{7} + {γ}_{8} + {γ}_{10} + {γ}_{11} )$ |
| ε₁₂ | $\frac{1}{2 \sqrt{6}} ( {γ}_{4} - {γ}_{1} - {γ}_{2} + {γ}_{5} + {γ}_{7} + {γ}_{8} - {γ}_{10} - {γ}_{11} ) + \frac{1}{2 \sqrt{2}} ( {γ}_{15} - {γ}_{16} - {γ}_{17} + {γ}_{18} )$ |
| ε₁₃ | $\frac{1}{2 \sqrt{6}} ( {γ}_{2} + {γ}_{3} + {γ}_{4} - {γ}_{6} - {γ}_{7} + {γ}_{9} - {γ}_{11} - {γ}_{12} ) + \frac{1}{2 \sqrt{2}} ( {γ}_{13} - {γ}_{14} - {γ}_{17} + {γ}_{18} )$ |
| ε₂₃ | $\frac{1}{2 \sqrt{6}} ( {γ}_{1} - {γ}_{3} - {γ}_{5} - {γ}_{6} + {γ}_{8} + {γ}_{9} - {γ}_{10} + {γ}_{12} ) + \frac{1}{2 \sqrt{2}} ( {γ}_{13} + {γ}_{14} + {γ}_{15} + {γ}_{16} )$ |

The anisotropic module 745 then returns the inelastic strain vector to either the fatigue module 730 or the creep module 740.

The ductility exhaustion module 750 determines a ratio of the available strain (ductility) to accumulated inelastic strain during a load cycle. The ratio represents the exhausted ductility and is a measure of damage of the single crystal turbine blade 430. The ratio may be expressed as a percentage of damage to the single crystal turbine blade 430 caused by that specific load cycle. This process can be repeated for a number of different load cycles, resulting in a damage factor (or ratio) for each cycle type. The total damage is therefore a summation of these damage factors up to 100% damage, at which point the component or location (depending on the type of damage, either local or bulk) is considered to have exhausted the available ductility and therefore is no longer capable of carrying load.

The accumulated strain during a load cycle is determined from the plastic response strain rate and the creep or viscoplastic response strain rate. Each strain rate may be referenced against a ductility exhaustion curve for the material of the single crystal turbine blade 430, such as the ductility exhaustion curve 812 illustrated in FIG. 3, to determine the accumulated damage for that strain rate. The accumulated damage for that strain rate is then divided by the available strain to return the percentage of damage caused by that strain rate.

The load cycle may include more than one ramp period and more than one dwell period. The percent damage for each ramp period and each dwell period in the load cycle are summed to determine the damage caused by the load cycle.

The lifing system 700 may also include a material data store 780 and a GTE data store 785. The data stores may be implemented using various database technologies that allow data to be organized, stored, and retrieved from the data stores. The data stores may be implemented on the same computer 710, server, or set of servers as the lifing system 700, remotely on a separate server or servers coupled to the lifing system 700, or some combination.

The material data store 780 may include a ductility exhaustion curve, such as the ductility exhaustion curve 812 of FIG. 3, an amount of available ductility or available strain, a stress-strain curve, such as the stress-strain curve 822 of FIG. 4, a stress tensor, an elastic stiffness tensor, and the slip system data for the material of the single crystal turbine blade 430, such as the data in Table 1 and Table 2. The stress-strain curve(s) and the ductility exhaustion curve may be stored as tables, equations, or by any other method in the material data store 780. The amount of available ductility may also be determined by using creep and tensile test data. The material data store 780 may include the data for multiple or alternate materials for single crystal turbine blades 430.

The GTE data store 785 includes the operating information of the GTE 100 that is input into the fatigue module 730 and the creep module 740. The operating information includes, inter alia, the operating temperatures such as the GTE inlet temperature and the turbine temperature, the operating pressures, the GTE loads, the GTE speeds, and the changes in time for the periods of a load cycle. This operating information can be for a specific model of GTE, which may include nominal information, can be for an individual GTE or a combination of the two. The GTE 100 may include sensors that measure the temperatures, pressures, and speed of the gas turbine engine 100 during the ramp period and the dwell periods. These measurements may be included in the GTE data store 785 and may be used to determine the ramp period stress and the dwell period stress in an orthotropic manner.

### INDUSTRIAL APPLICABILITY

Turbine blades of small to medium sized industrial gas turbine engines may operate at temperatures of 1000 degrees Fahrenheit or more and at speeds of 10,000 revolutions per minute or more. To operate in such an environment, turbine blades may be manufactured as a single crystal from a super alloy material, such as a CMSX single crystal alloy. This manufacturing process is an expensive process using expensive materials.

Lifing systems for turbine blades are generally conservative to avoid failure of the turbine blade during operation. Failure of a turbine blade may lead to extensive damage to the gas turbine engine and in particular the turbine section, often resulting in unintended shutdowns and loss of productivity. While avoiding failure, turbine blades are often discarded and replaced well before the turbine blade might fail.

A single crystal turbine blade lifing system and process that may more accurately predict when a single crystal turbine blade 430 might fail may allow the single crystal turbine blades 430 to remain in operation longer without increasing the risk of failure. Increasing the time each single crystal turbine blade 430 remains in operation may significantly reduce the costs of operating a gas turbine engine as the expense of replacing the single crystal turbine blades 430 may occur less frequently.

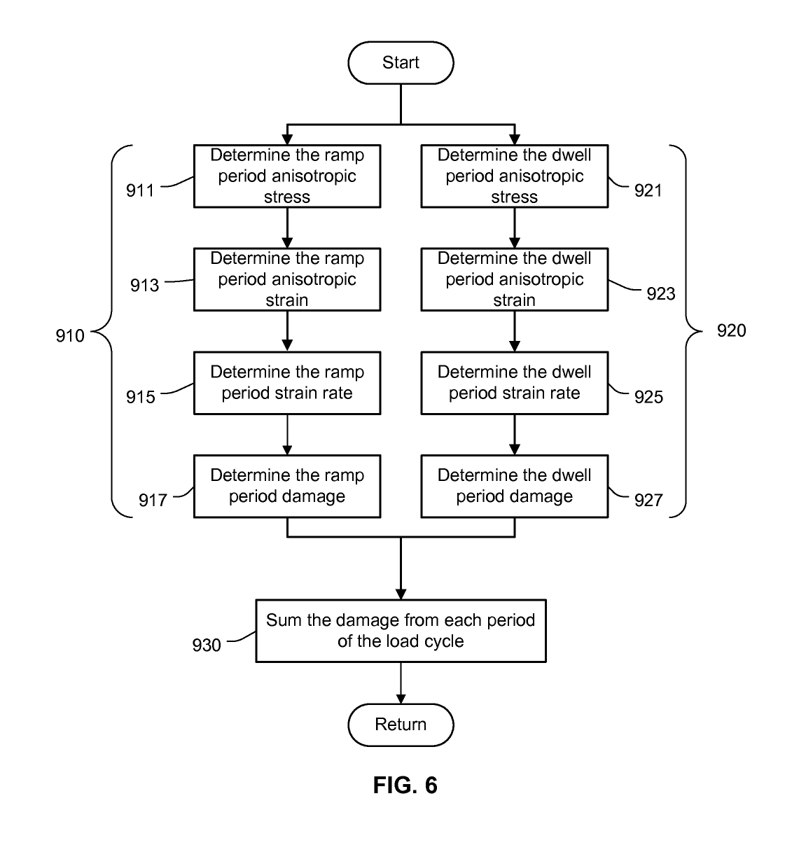

FIG. 6 is a flowchart of a process for determining the damage accumulated on a single crystal turbine blade, such as the turbine blade 430 of FIG. 2, caused by a gas turbine engine load cycle. The process can be performed by the lifing system 700 of FIG. 5. Various steps of the process can be performed by the fatigue module 730, the creep module 740, the anisotropic module 745, or the ductility exhaustion module 750 of the lifing system 700 of FIG. 5.

The process for determining the damage accumulated on a single crystal turbine blade 430 during one load cycle includes processes for determining the damage to the single crystal turbine blade 430 due to one or more ramp periods and the damage due to one or more dwell periods of a load cycle to account for fatigue and creep respectively of the load cycle. As illustrated in FIG. 6, the process may include a fatigue sub-process 910 and a creep sub-process 920.

In block 911, the fatigue sub-process 910 determines the ramp period anisotropic stress or fatigue stress (plastic response stress) due to the ramp period. The ramp period anisotropic stress may be determined by determining the ramp period or plastic response stresses in an orthotropic manner with the fatigue module 730, converting the ramp period stresses into a ramp period anisotropic strain vector using the resolved shear stresses on the primary slip systems with the anisotropic module 745, determining a ramp period anisotropic elastic strain vector with the anisotropic module 745, and applying the relationship between the shear modulus, shear strain, and shear stress to obtain the ramp period stress from the anisotropic elastic strain vector with the fatigue module 730 by subtracting the ramp period anisotropic strain vector from the total ramp period strain as describe above.

In block 913, the fatigue sub-process 910 determines the ramp period anisotropic strain with the fatigue module 730. The ramp period anisotropic strain may be determined with the fatigue module 730 using a stress-strain curve developed for the material used in the single crystal turbine blade 430, such as the stress-strain curve 822 of FIG. 4. The anisotropic strain for a load cycle may be expressed as a resultant stress-strain curve over the load cycle.

In block 915, the fatigue sub-process 910 determines the ramp period strain rate with the fatigue module 730. The ramp period strain rate may be determined by the plastic response curve at the given temperature and operating conditions or by other methods that correlate the ramp period anisotropic strain to the length or duration of the ramp period. The ramp period strain rate may be an average of the strain rate for the inelastic portion of the ramp period.

In block 917, the fatigue sub-process 910 determines the ramp period damage with the ductility exhaustion module 750. The ramp period damage may be determined by referencing the ramp period strain rate to the ductility exhaustion curve for the material used in the single crystal turbine blade 430, such as the ductility exhaustion curve 812 of FIG. 3, or by using the resulting ramp period strain rate with the ductility exhaustion curve data.

In block 921, the creep sub-process 920 determines the dwell period anisotropic stress or creep stress (viscoplastic response stress) due to the dwell period. The dwell period anisotropic stress may be determined by determining the dwell period or viscoplastic response stresses in an orthotropic manner with the creep module 740, converting the dwell period stresses into a dwell period anisotropic strain vector using the resolved shear stresses on the primary slip systems with the anisotropic module 745, determining a dwell period anisotropic elastic strain vector with the anisotropic module 745, and applying the relationship between the shear modulus, shear strain, and shear stress to obtain the dwell period stress from the anisotropic elastic strain vector with the creep module 740 by subtracting the dwell period anisotropic strain vector from the total dwell period strain as describe above.

In block 923, the creep sub-process 920 determines the dwell period anisotropic strain with the creep module 740. The dwell period anisotropic strain may be determined from a strain-time curve developed for the material used in the single crystal turbine blade 430, typically seen in creep test data.

In block 925, the creep sub-process 920 determines the dwell period strain rate with the creep module 740. The dwell period strain rate may be determined from calculating the anisotropic stress and temperature during the dwell period and the anisotropic stress and temperature in a typical strain rate based creep model, such as a power law creep equation. The creep or anisotropic viscoplastic strain can be obtained from the anisotropic stress and temperature over the dwell period.

In block 927, the creep sub-process 920 determines the dwell period damage with the ductility exhaustion module 750. The dwell period damage may be determined by referencing the dwell period strain rate to the ductility exhaustion curve for the material used in the single crystal turbine blade 430, such as the ductility exhaustion curve 812 of FIG. 3, or by using the resulting dwell period strain rate with the ductility exhaustion curve data. The dwell period strain rate may be an average of the strain rate for the inelastic portion of the dwell period.

In block 930, the process sums the damage from each period of the load cycle with the ductility exhaustion module 750. The fatigue sub-process 910 may determine the damage for one or more ramp periods and the creep sub-process 920 may determine the damage for one or more dwell periods depending on the number of ramp periods and dwell periods in the load cycle. The sum of the damage for the load cycle includes the damage from at least one ramp period and at least one dwell period and may include the damage from multiple ramp periods and the damage from multiple dwell periods.

The process for determining the damage accumulated on a single crystal turbine blade 430 during a load cycle, in various embodiments, may add, omit, reorder, or alter the illustrated blocks. For example, the fatigue sub-process 910 may be performed concurrently to the creep sub-process 920 as illustrated, may be performed prior to the creep sub-process 920, or may be performed after the creep sub-process 920. Determining the damage for multiple ramp periods or multiple dwell periods may also be performed concurrently or serially.

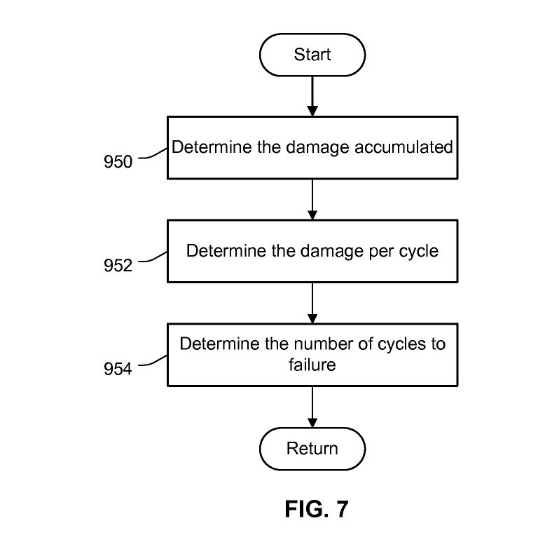

The process for determining the damage accumulated on a single crystal turbine blade 430 during a load cycle may be used to project the operating life of a single crystal turbine blade 430 or may be used to monitor the operating life of a single crystal turbine blade 430. FIG. 7 is a flowchart of a process for determining the operating life of a single crystal turbine blade such as the single crystal turbine blade 430 of FIG. 2. The process can be performed by the lifing system 700 of FIG. 5. Various steps of the process can be performed by the fatigue module 730, the creep module 740, the anisotropic module 745, or the ductility exhaustion module 750 of the lifing system 700 of FIG. 5.

In block 950, the process determines the damage accumulated on a single crystal turbine blade 430 caused by at least one load cycle that may include one or more load cycle type. When more than one cycle is used, the process determines a total accumulated damage by adding the damage from the load cycle to the accumulated damage from the previous load cycles.

In block 952, the process determines the damage per cycle. This may be done by dividing the damage accumulated by the number of load cycles to average the amount of damage caused per cycle. In some embodiments, nominal input values may be used in block 950 to determine the nominal damage of a single nominal load cycle. In these embodiments, the single nominal load cycle is considered the damage per cycle.

In block 954, the process determines the number of cycles to failure by dividing the total available damage by the damage per cycle. The damage per cycle may be expressed as a percentage. In such cases, the total available damage may be expressed as one-hundred percent and the number of cycles to failure is determined by dividing one-hundred percent by the percent damage per cycle. This approach can also accommodate any number of safety factors, by limiting the total available damage to less than one-hundred percent or less than the total number of hours to exhaust the ductility, depending on the application and the level of risk, the reliability level, or the confidence level associated with that application.

The operating life of a single crystal turbine blade 430 may be predicted by projecting the damage per cycle out over time or by determining the number of operating hours to failure. The number of operating hours to failure may be determined from the number of cycles to failure by multiplying the number of cycles to failure by the average number of operating hours per cycle.

The damage accumulated on a turbine blade during a load cycle of a gas turbine engine, the number of cycles to failure, and the number of operating hours to failure may be used by processes, methods, and systems of service for GTE 100. Such a process may use damage accumulated on a turbine blade during a load cycle of a gas turbine engine, the exhausted ductility, the number of cycles to failure, and the number of operating hours to failure to determine whether or not to replace the single crystal turbine blades 430 during a particular service of GTE 100 or to wait for a subsequent service of the GTE 100. Service of GTE 100 may include overhaul, field service or modification, or refurbishing of GTE 100.

Those of skill will appreciate that the various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the design constraints imposed on the overall system. Skilled persons can implement the described functionality in varying ways for each particular application, but such implementation decisions should not be interpreted as causing a departure from the scope of the invention. In addition, the grouping of functions within a module, block, or step is for ease of description. Specific functions or steps can be moved from one module or block without departing from the invention.

The various illustrative logical blocks and modules described in connection with the embodiments disclosed herein can be implemented or performed with a general purpose processor, a digital signal processor (DSP), application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor (e.g., of a computer), or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A method for determining the damage accumulated on a turbine blade during a load cycle of a gas turbine engine, the load cycle including a ramp period and a dwell period, and the turbine blade being formed with a single crystal of a material and including primary slip systems, the method comprising:
determining a ramp period anisotropic stress including resolving a ramp period stress determined in an orthotropic manner into ramp period shear stresses on the primary slip systems of the turbine blade;
determining a ramp period anisotropic strain from the ramp period anisotropic stress using a stress-strain curve for the material;
determining a ramp period strain rate from the ramp period anisotropic strain;
determining a ramp period damage from the ramp period strain rate by using a ductility exhaustion curve for the material;
determining a dwell period anisotropic stress including resolving a dwell period stress determined in an orthotropic manner into dwell period shear stresses on the primary slip systems of the turbine blade;
determining a dwell period anisotropic strain from the dwell period anisotropic stress;
determining a dwell period strain rate from the dwell period anisotropic strain;
determining a dwell period damage from the dwell period strain rate by using the ductility exhaustion curve for the material; and
combining the ramp period damage and the dwell period damage for the load cycle to get the damage accumulated on the turbine blade during the load cycle.

2. The method of claim 1, wherein determining the ramp period anisotropic stress includes using the shear modulus to determine ramp period shear strains on the primary slip systems from the ramp period shear stresses on the primary slip systems, combining the ramp period shear strains on the primary slip systems into a ramp period anisotropic strain vector, subtracting the ramp period anisotropic strain vector from a total ramp period strain, and multiplying by an elastic stiffness tensor for the material; and wherein determining the dwell period anisotropic stress includes using the shear modulus to determine dwell period shear strains on the primary slip systems from the dwell period shear stresses on the primary slip systems, combining the dwell period shear strains on the primary slip systems into a dwell period anisotropic strain vector, subtracting the dwell period anisotropic strain vector from a total dwell period strain, and multiplying by the elastic stiffness tensor.

3. The method of claim 2, wherein equilibrium equations are used in a finite element analysis model to determine the ramp period anisotropic stress and the dwell period anisotropic stress.

4. The method of claim 1, wherein a power law approach is used to determine the dwell period strain rate.

5. The method of claim 1, wherein the stress-strain curve and the ductility exhaustion curve are developed for the material by creep and tensile tests of the material.

6. The method of claim 1, further comprising combining the ramp period damage and the dwell period damage for multiple load cycles to determine a total damage to the turbine blade.

7. The method of claim 1, wherein the ramp period shear stress on each of the primary slip systems is determined by multiplying the ramp period stress by the cosine of the angle between a normal of the slip plane and a direction of the applied force and the cosine of the angle between the slip plane direction and the direction of the applied force, and the dwell period shear stress on each of the primary slip systems is determined by multiplying the dwell period stress by the cosine of the angle between the normal of the slip plane and the direction of the applied force and the cosine of the angle between the slip plane direction and the direction of the applied force.

8. A method of service for the gas turbine engine, wherein determining whether to replace the turbine blade during service of the gas turbine engine is based on the damage accumulated on the turbine blade according to the method of claim 1.

9. A method for determining an operating life for a single crystal turbine blade of a gas turbine engine, the method comprising:
determining an accumulated damage for the single crystal turbine blade for each load cycle of the gas turbine engine including
determining a fatigue damage including resolving a ramp period stress determined in an orthotropic manner into ramp period shear stresses on the primary slip systems of the turbine blade and using a resulting ramp period strain rate with a ductility exhaustion curve for a material of the single crystal turbine blade,
determining a creep damage including resolving a dwell period stress determined in an orthotropic manner into dwell period shear stresses on the primary slip planes and using a resulting dwell period strain rate with the ductility exhaustion curve, and
combining the fatigue damage and the creep damage;
determining a damage per cycle by combining the accumulated damage for the single crystal turbine blade for each load cycle into a total accumulated damage and dividing the total accumulated damage by the number of load cycles; and
determining a number of cycles to failure by dividing a total damage to failure by the damage per cycle.

10. The method of claim 8, wherein a failure of the single crystal turbine blade is predicted by projecting the damage per cycle out over time.

11. The method of claim 8, wherein determining the fatigue damage includes using the shear modulus to determine ramp period shear strains on the primary slip systems from the ramp period shear stresses on the primary slip systems, combining the ramp period shear strains on the primary slip systems into a ramp period anisotropic strain vector, subtracting the ramp period anisotropic strain vector from a total ramp period strain, and multiplying by an elastic stiffness tensor for the material to determine a ramp period anisotropic stress; and wherein determining the creep damage includes using the shear modulus to determine dwell period shear strains on the primary slip systems from the dwell period shear stresses on the primary slip systems, combining the dwell period shear strains on the primary slip systems into a dwell period anisotropic strain vector, subtracting the dwell period anisotropic strain vector from a total dwell period strain, and multiplying by the elastic stiffness tensor to determine a dwell period anisotropic stress.

12. The method of claim 11, wherein determining the fatigue damage includes using a stress-strain curve to determine a ramp period anisotropic strain from the ramp period anisotropic stress, and wherein determining the creep damage includes using the stress-strain curve to determine a dwell period anisotropic strain from the dwell period anisotropic stress.

13. The method of claim 12, wherein a power law approach is used to determine the dwell period strain rate from the dwell period anisotropic strain.

14. The method of claim 8, wherein the ramp period shear stress on each of the primary slip systems is determined by multiplying the ramp period stress by the cosine of the angle between a normal of the slip plane and a direction of the applied force and the cosine of the angle between the slip plane direction and the direction of the applied force, and the dwell period shear stress on each of the primary slip systems is determined by multiplying the dwell period stress by the cosine of the angle between the normal of the slip plane and the direction of the applied force and the cosine of the angle between the slip plane direction and the direction of the applied force.

15. A method of service for the gas turbine engine, wherein determining whether to replace the turbine blade during service of the gas turbine engine is based on the number of cycles to failure, determined by the method of claim 8.

16. The method of claim 8, wherein the total damage to failure is determined by creep and tensile tests.

17. The method of claim 8, wherein the ductility exhaustion curve is determined by creep and tensile tests.

18. A lifing system for a single crystal turbine blade of a gas turbine engine, the lifing system comprising:
a processor;
a material data store including a stress-strain curve and a ductility exhaustion curve for a material of the single crystal turbine blade;
a gas turbine engine data store including operating conditions of at least one load cycle, the load cycle including a ramp period and a dwell period;
an anisotropic module configured to convert stresses determined in an orthotropic manner into an anisotropic inelastic strain vector by determining the resolved shear stresses on the primary octahedral slip systems and the primary cubic slip systems;
a fatigue module configured to determine plastic response stresses of a ramp period in an orthotropic manner, provide the plastic response stresses to the anisotropic module, receive an anisotropic plastic response inelastic strain vector from the anisotropic module, and determine a plastic response strain rate from the anisotropic plastic response inelastic strain vector;
a creep module configured to determine viscoplastic response stresses of the dwell period in an orthotropic manner, provide the viscoplastic response stresses to the anisotropic module, receive an anisotropic viscoplastic response inelastic strain vector from the anisotropic module, and determine a viscoplastic response strain rate from the anisotropic viscoplastic response inelastic strain vector; and
a ductility exhaustion module configured to determine the exhausted ductility of the single crystal turbine blade by determining an accumulated inelastic strain of the load cycle with the plastic response strain rate, the viscoplastic response strain rate, and a ductility exhaustion curve, and comparing the accumulated inelastic strain to an available strain.

19. The lifing system of claim 18, wherein the anisotropic module determines the resolved shear stresses on each of the primary octahedral slip systems and each of the primary cubic slip systems by multiplying the plastic response stress by the cosine of the angle between a normal of the slip plane and a direction of the applied force and the cosine of the angle between the slip plane direction and the direction of the applied force, and the viscoplastic response stress by the cosine of the angle between a normal of the slip plane and a direction of the applied force and the cosine of the angle between the slip plane direction and the direction of the applied force.

20. A system of service for the gas turbine engine, wherein determining whether to replace the turbine blade during service of the gas turbine engine is based on the number of cycles to failure exhausted ductility determined by the lifing system of claim 18.
